(19) United States
(12) Patent Application Publication
(10) Pub. No.: US 2018/0126904 A1
(43) Pub. Date: May 10, 2018

(54) VEHICLE REAR REGION IMAGE DISPLAY DEVICE, AND NON-TRANSITORY COMPUTER-READABLE MEDIUM STORING VEHICLE REAR REGION IMAGE DISPLAY PROGRAM

(71) Applicant: TOYOTA JIDOSHA KABUSHIKI KAISHA, Toyota-shi (JP)

(72) Inventors: Masaaki AMANO, Nagoya-shi (JP); Goro ASAI, Toyota-shi (JP); Takumi KOCHIYA, Nisshin-shi (JP)

(73) Assignee: TOYOTA JIDOSHA KABUSHIKI KAISHA, Toyota-shi (JP)

(21) Appl. No.: 15/700,323

(22) Filed: Sep. 11, 2017

(30) Foreign Application Priority Data
Nov. 8, 2016 (JP) 2016-218143

(51) Int. Cl. B60R 1/00; H04N 5/232

(52) U.S. Cl. CPC B60R 1/00; B60R 2300/8026; B60R 2300/60; H04N 5/23264

(57) ABSTRACT

The present disclosure provides a vehicle rear region image display device that may suppress a sense of incongruity to a displayed image, due to offset in timings between a timing at which a vehicle occupant sways due to vibrations and a timing at which the displayed image of a display section shakes. Namely, an acceleration sensor, which detects acceleration as a physical amount corresponding to an amount of displacement in a vehicle vertical direction of a rearview mirror monitor due to vibrations inputted to front wheels of a vehicle, is provided in a vicinity of the rearview mirror monitor. On the basis of results of detection of the acceleration sensor, a control device computes an amount of shake of a rear camera, and carries out shake correction so as match a timing at which vibrations are inputted to rear wheels of the vehicle.

### CROSS-REFERENCE TO RELATED APPLICATION

This application claims priority under 35 USC 119 from Japanese Patent Application No. 2016-218143, filed Nov. 8, 2016, the disclosure of which is incorporated by reference herein.

### BACKGROUND

### Technical Field

The present disclosure relates to a vehicle rear region image display device and to a non-transitory computer-readable medium storing a vehicle rear region image display program, which are installed in a vehicle and display captured images of a vehicle rear region.

### Related Art

There are known vehicle rear region image display devices that enable viewing of the rear region of a vehicle by capturing images of the rear region of the vehicle by an imaging section such as a camera or the like, and displaying the captured images on a display section, such as a monitor or the like that is within the vehicle cabin.

For example, in the technique described in Japanese Patent Application Laid-Open (JP-A) No. 2009-100180, because the imaging position of a rear camera and the viewpoint of the driver are offset in the horizontal direction and the vertical direction, this technique proposes generating an artificial image, in which the viewpoint of the rear camera is moved to the position of the viewpoint of the driver, and displaying the artificial image on a display.

By the way, in a conventional, optical-type rearview mirror, the position of the vehicle occupant and the position of the rearview mirror are substantially the same position in the vehicle longitudinal direction. Therefore, swaying of the rearview mirror, which is due to vibrations when the vehicle rides-over a step, arise synchronously with vibrations of the vehicle occupant. Accordingly, the timing at which the vehicle occupant sways and the timing at which the optical image reflected in the rearview mirror sways, coincide with one another. Therefore, no sense of incongruity occurs even in a case in which the vehicle occupant is checking the rearview mirror at the time of riding-over a step.

However, in a technique in which images captured by an imaging section disposed at the vehicle rear portion are displayed on a display section provided within the vehicle cabin as in the technique of JP-A No. 2009-100180, at the time when the vehicle rides-over a step in the road, the timings of the vibrations of the imaging section and the display section do not coincide. Namely, vibrations of the display section are inputted mainly at the time when the front wheels ride-over a step, and vibrations to the imaging section are inputted mainly at the time when the rear wheels ride-over a step. Therefore, the timing at which the vehicle occupant sways due to vibrations and the timing at which the image shakes are offset from one another, and thus, there is the concern that the vehicle occupant will feel a sense of incongruity to the displayed image of the display section.

### SUMMARY

The present disclosure provides a vehicle rear region image display device and a non-transitory computer-readable medium storing a vehicle rear region image display program that may suppress the sense of incongruity to a displayed image, due to offset of the timings between the timing at which a vehicle occupant sways due to vibrations and the timing at which the displayed image of a display section shakes.

A first aspect of the present disclosure is a vehicle rear region image display device including: an imaging section provided at a vehicle rear portion, the imaging section configured to capture images of a vehicle rear region; a display section provided at a front portion of a vehicle cabin interior, the display section configured to display a displayed image that is obtained by cutting out a predetermined range from the captured image; a detecting section configured to detect a physical amount corresponding to an amount of displacement in a vehicle vertical direction of the display section due to vibrations at front wheels of a vehicle; and a control section configured to carry out adjustment control that adjusts a position of cutting out the displayed image from the captured image on the basis of the physical amount, at a timing at which vibrations are inputted to rear wheels of the vehicle by an object that caused input of the vibrations to the front wheels of the vehicle.

In accordance with the first aspect of the present disclosure, the imaging section is provided at the vehicle rear portion and images of the vehicle rear region are captured thereby.

The display section is provided at the front portion of the vehicle cabin interior, and displays the displayed image that is obtained by cutting out a predetermined range from the captured image obtained by the imaging section.

A physical amount, which corresponds to the amount of displacement in the vehicle vertical direction of the display section due to vibrations inputted to the front wheels of the vehicle, is detected by the detecting section. For example, as the detecting section, an acceleration sensor may be provided in a vicinity of the display section, and may detect acceleration as the physical amount. On the other hand, the stroke of the front suspension may be detected as the physical amount.

Further, at the control section, on the basis of the physical amount detected by the detecting section, adjustment control, which adjusts the position of cutting out of the displayed image from the captured image, is carried out so as to match the timing at which the vibrations, which were inputted to the front wheels, are inputted to the rear wheels of the vehicle. Due thereto, in the first aspect of the present disclosure, shaking of the displayed image, which is displayed on the display section, due to vibrations inputted to the rear wheels may be suppressed. Accordingly, the first aspect of the present disclosure may suppress a sense of incongruity to the displayed image, due to offset between the timing at which the vehicle occupant sways due to vibrations, and the timing at which the displayed image of the display section shakes.

A second aspect of the present disclosure, in the first aspect, may further include: a frequency detecting section configured to detect a frequency of the vibrations, the control section may be configured to carry out the adjustment control in a case in which the frequency detected by the frequency detecting section is lower than a frame rate of the imaging of the imaging section.

Namely, in a case of vibrations that are equal to or greater than the frame rate of the imaging section are input, shake correction cannot be carried out with respect to vibrations that are of a timing corresponding to the interval between image frames, and therefore, shake correction becomes unnatural. However, in the second aspect of the present disclosure, by carrying out shake correction in a case in which the frequency of the vibrations is lower than the frame rate, natural shake correction may be possible.

In a third aspect of the present disclosure, in the above-described first and second aspect, the timing may be estimated on the basis of vehicle speed and a length of a wheelbase of the vehicle.

Namely, in a case in which the vehicle speed and the length of the wheelbase are known, the timing at which vibrations are inputted to the rear wheels (the delay time from the time that vibrations are inputted to the front wheels until the time that vibrations are inputted to the rear wheels) is known. Accordingly, the third aspect of the present disclosure may estimate that timing at which adjustment control is to be carried out.

A fourth aspect of the present disclosure is a non-transitory computer-readable medium storing a vehicle rear region image display program for causing a computer to function as the control section of the vehicle rear region image display device of any one of the above aspects.

As described above, the above-described aspects of the present disclosure provides a vehicle rear region image display device and a non-transitory computer-readable medium storing a vehicle rear region image display program that may suppress the sense of incongruity to a displayed image, due to offset of timings between the timing of a vehicle occupant swaying due to vibrations and the timing of shaking of the displayed image of a display section.

### BRIEF DESCRIPTION OF THE DRAWINGS

Exemplary embodiments will be described in detail based on the following figures, wherein:

FIG. 1A is a drawing illustrating an installed position in a vehicle, at a vehicle front side, of a vehicle rear region image display device relating to a present exemplary embodiment;

FIG. 1B is a drawing illustrating an installed position in the vehicle, at a vehicle rear side, of the vehicle rear region image display device relating to the present exemplary embodiment;

FIG. 2 is a block diagram illustrating a configuration of a control system of the vehicle rear region image display device relating to the present exemplary embodiment;

FIG. 3 is a flowchart illustrating an example of display control carried out by a control device of the vehicle rear region image display device relating to the present exemplary embodiment; and

FIG. 4 is flowchart illustrating a modified example of display control carried out by the control device of the vehicle rear region image display device relating to the present exemplary embodiment.

### DETAILED DESCRIPTION

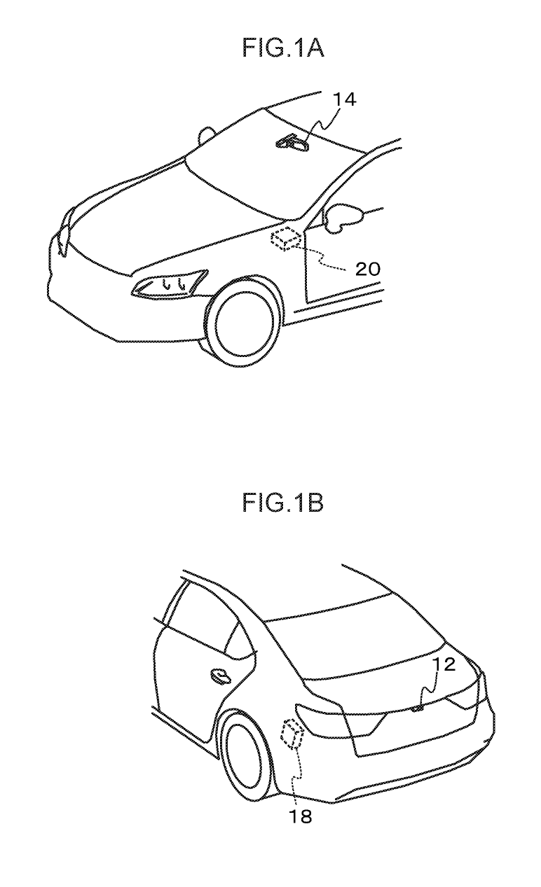

An example of an embodiment of the present disclosure is described in detail hereinafter with reference to the drawings. FIG. 1A is a drawing illustrating an installed position in a vehicle, at the vehicle front side, of a vehicle rear region image display device relating to a present exemplary embodiment, and FIG. 1B is a drawing illustrating the vehicle rear side.

The vehicle rear region image display device relating to the present exemplary embodiment captures images of the vehicle rear region by a rear camera 12 that serves as an example of an imaging section that is provided at the vehicle rear portion, and displays the captured images on a rearview mirror monitor 14 that serves as an example of a display section and is provided at the position of the rearview mirror within the vehicle cabin. By providing the rearview mirror monitor 14 at the position of the rearview mirror, the rearview mirror monitor 14 may function as the rearview mirror.

Further, an acceleration sensor 20, which serves as an example of a detecting section and a frequency detecting section, is provided in a vicinity of the rearview mirror monitor 14 that is within the vehicle cabin. In the present exemplary embodiment, the acceleration sensor 20 detects acceleration applied to the vehicle as a physical amount that corresponds to the amount of displacement of the rearview mirror monitor 14 in the vehicle vertical direction that is due to vibrations inputted to the front wheels of the vehicle. As the vicinity of the rearview mirror monitor 14, it suffices for the position thereof in the vehicle longitudinal direction to be the same position as the position of the rearview mirror monitor 14. For example, the acceleration sensor 20 may be disposed within the instrument panel or the like at the front portion of the vehicle cabin interior, or may be disposed at the lower portion of a vehicle seat. Note that the frequency of the vibrations that are inputted to the vehicle also can be detected from the results of detection of the acceleration sensor 20.

Further, a control device 18, which serves as an example of a control section that controls the rear camera 12 and the rearview mirror monitor 14, is provided within the trunk. Although an example in which the control device 18 is provided within the trunk is described, the placement of the control device 18 is not limited to this, and the control device 18 may be provided at another place within the vehicle cabin.

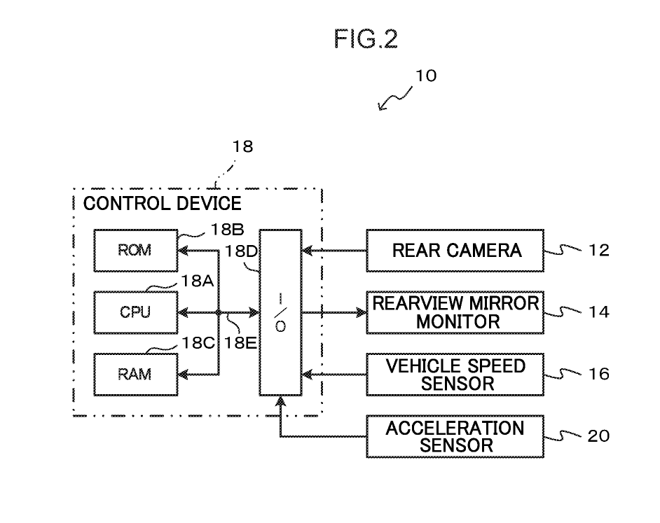

FIG. 2 is a block drawing illustrating the schematic configuration of the control system of a vehicle rear region image display device 10 relating to the present exemplary embodiment.

The vehicle rear region image display device 10 relating to the present exemplary embodiment has the rear camera 12, the rearview mirror monitor 14, a vehicle speed sensor 16, the acceleration sensor 20, and the control device 18.

The rear camera 12 outputs results of imaging, in which images of the vehicle rear region have been captured, to the control device 18. The rear camera 12 is disposed, for example, at the rear portion of the exterior of the vehicle (e.g., at the trunk that is shown in FIG. 1B, or the like), and captures images of the vehicle rear region. Note that, in the present exemplary embodiment, an example in which the rear camera 12 is provided at the exterior of the vehicle cabin is described, but the rear camera 12 may be provided at the vehicle cabin interior.

The vehicle speed sensor 16 detects the vehicle speed, and outputs the results of detection to the control device 18. The vehicle speed sensor 16 is provided at a region where the rotational speed varies in accordance with the vehicle speed, such as at, for example, a brake rotor or the transmission or the like, and detects the rotational speed or the like that corresponds to the vehicle speed.

The acceleration sensor 20 detects the acceleration that is applied to the vehicle, and outputs the results of detection to the control device 18. As described above, the acceleration sensor 20 is provided in a vicinity of the rearview mirror monitor 14 within the vehicle cabin. The acceleration sensor 20 detects the acceleration that arises due to vibrations or the like that are inputted mainly from the front wheels of the vehicle. Note that the acceleration sensor 20 may be used in common for another device (e.g., an airbag device or the like).

The control device 18 is configured by a microcomputer in which a CPU 18A, a ROM 18B, a RAM 18C and an I/O (input/output interface) 18D are respectively connected to a bus 18E.

Various types of programs, such as a program for carrying out display control that displays on the respective monitors 14 the captured images that have been captured by the respective cameras 12, are stored in the ROM 18B. Control of display of the captured images onto the respective monitors, and the like are carried out due to programs that are stored in the ROM 18B being expanded in the RAM 18C and being executed by the CPU 18A.

The rear camera 12, the rearview mirror monitor 14, the vehicle speed sensor 16 and the acceleration sensor 20 are respectively connected to the I/O 18D. The control device 18 acquires the results of imaging of the rear camera 12, and carries out, on the captured images, processings for display onto the rearview mirror monitor 14 (e.g., processings such as mirror image conversion that reverses the left and the right of the captured image, and the like), and displays the captured images on the rearview mirror monitor 14.

By the way, in the present exemplary embodiment, vibrations of the rearview mirror monitor 14 are inputted mainly in a case in which the front wheels ride-over a step. On the other hand, vibrations of the rear camera 12 are inputted mainly in a case in which the rear wheels ride-over a step. Namely, the timings of the vibrations inputted respectively to the rearview mirror monitor 14 and the rear camera 12 becomes offset from one another. Accordingly, the timing at which the vehicle occupant, who is seated at substantially the same position as the rearview mirror monitor 14 in the vehicle longitudinal direction, sways due to vibrations, and the timing at which the image that is displayed on the rearview mirror monitor 14 shakes, becomes offset from one another. Therefore, there is the concern that the vehicle occupant will feel a sense of incongruity in the displayed image.

Thus, in the present exemplary embodiment, as described above, the acceleration sensor 20, which detects acceleration as a physical amount corresponding to the amount of displacement in the vehicle vertical direction of the rearview mirror monitor 14 due to vibrations that are inputted to the front wheels of the vehicle, is provided in a vicinity of the rearview mirror monitor 14. Further, on the basis of the results of detection of the acceleration sensor 20, the control device 18 computes an amount of shaking of the rear camera 12, and carries out shake correction so as to match the timing at which vibrations are inputted to the rear wheels of the vehicle.

In the present exemplary embodiment, explanation is given of a displayed image, which is obtained by cutting out a portion of the image captured by the rear camera 12, being displayed on the rearview mirror monitor 14, and shake correction being carried out by carrying out adjustment control that adjusts the position of the displayed image that is cut out from the captured image.

Further, the timing at which vibrations are inputted to the rear wheels of the vehicle can be estimated from the length of the wheelbase and the vehicle speed. Therefore, in the present exemplary embodiment, this timing is estimated on the basis of the wheelbase and the vehicle speed that is detected by the vehicle speed sensor 16. For example, vibration timings of the rear wheels (delay times from the input of vibrations to the front wheels) that correspond to vehicle speeds may be determined in advance and stored as a table, and the delay time that corresponds to the vehicle speed may be read-out as the vibration timing of the rear wheels. Note that the timing at which vibrations are inputted to the rear wheels of the vehicle may be detected by separately providing a sensor that detects vibrations that are inputted to the rear wheels of the vehicle.

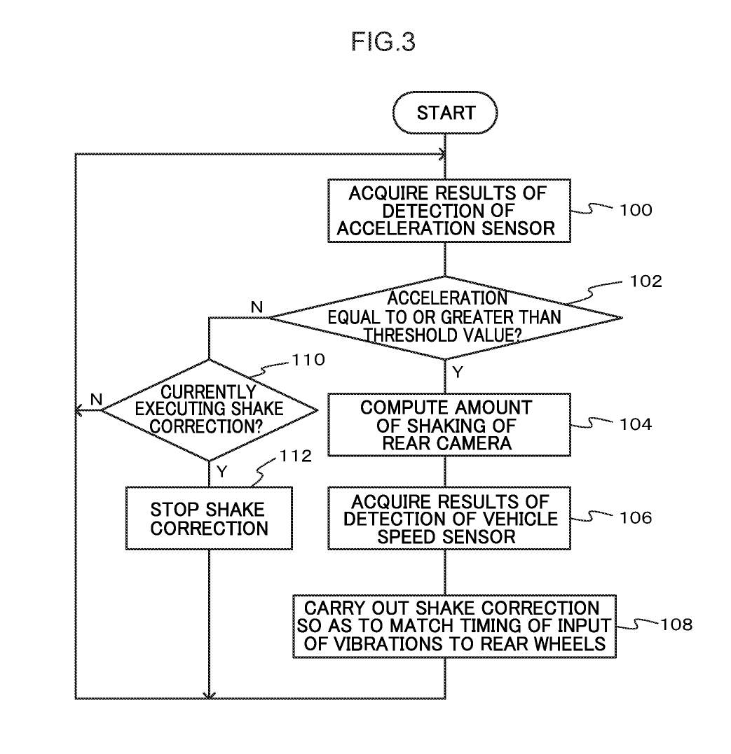

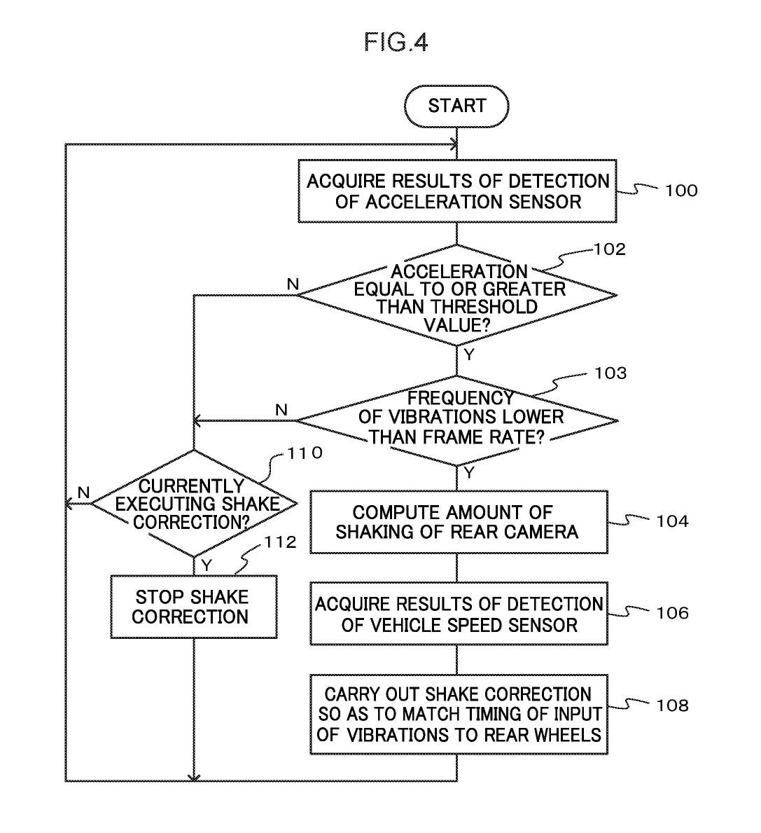

Processings that are carried out at the control device 18 of the vehicle rear region image display device 10, which relates to the above described present exemplary embodiment, are described next. FIG. 3 is a flowchart illustrating an example of display control that is carried out at the control device 18 of the vehicle rear region image display device 10 relating to the present exemplary embodiment. Note that the processings of FIG. 4 start, for example, when an ignition switch (not illustrated) is turned ON.

In step 100, the CPU 18A acquires the results of detection of the acceleration sensor 20, and the process proceeds to step 102.

In step 102, the CPU 18A determines whether or not the detected acceleration is equal to or greater than a predetermined threshold value. In a case in which this determination is affirmative, the process proceeds to step 104, and in a case in which this determination is negative, the process proceeds to step 110. Note that, for example, a value that is determined in advance on the basis of the resolution of the rear camera 12 or the processing speed of the CPU 18A or the like is used as the predetermined threshold value.

In step 104, the CPU 18A computes the amount of shake of the rear camera, and the process proceeds to step 106. The vertical amount of displacement of the front wheels can be determined from the acceleration detected by the acceleration sensor 20. Because the rear wheels ride-over the step that the front wheels have ridden-over, the vertical amount of displacement that is determined from the acceleration detected by the acceleration sensor 20 is computed as the amount of shake of the camera.

In step 106, the CPU 18A acquires the results of detection of the vehicle speed sensor 16, and the process proceeds to step 108.

In step 108, the CPU 18A carries out shake correction so as to match the timing at which vibrations are inputted to the rear wheels, and the process returns to step 100, and the above-described processes are repeated. Namely, the delay time from the time that vibrations are inputted to the front wheels until the time that vibrations are inputted to the rear wheels is determined from the vehicle speed detected by the vehicle speed sensor 16. Then, at the time when the determined delay time is reached, the above-described adjustment control is carried out, in accordance with the amount of shake computed in step 106. Due thereto, even in a case in which vibrations are inputted to the rear wheels, shake correction is carried out such that the image does not shake at the time when vibrations are inputted to the rear camera 12. Therefore, a sense of incongruity due to offset in the timing, at which the vehicle occupant sways due to vibrations, and the timing, at which the image displayed on the rearview mirror monitor 14 shakes, may be suppressed.

On the other hand, in step 110, in a case in which the vibrations are weak, the CPU 18A determines whether or not processing is currently executing the shake correction. This determination is to determine whether or not step 108 has already been executed, and whether or not the shake correction is being carried out. In a case in which this determination is affirmative, the process proceeds to step 112. In a case in which this determination is negative, the process returns to step 100, and the above-described processings are repeated.

In step 112, the CPU 18A stops the shake correction, and the process returns to step 100, and the above-described processings are repeated.

Due to the control device 18 carrying out processing in this way, a sense of incongruity that is due to offset in the timing, at which the vehicle occupant sways due to vibrations, and the timing, at which the image displayed on the rearview mirror monitor 14 shakes, may be suppressed.

Further, there is the concern that the vehicle occupant may experience visually-induced motion sickness due to the sensory contradiction between the visual sense and the physical sense with respect to the vibrations. However, in the present exemplary embodiment, the visually-induced motion sickness may be suppressed by suppressing the sense of incongruity as described above.

By the way, in the case in which the frequency of the vibrations is equal to or greater than the frame rate of imaging by the rear camera 12, correction cannot be carried out with respect to vibrations of a timing that corresponds to the interval between an image frame and the next image frame. Because correction cannot be completely carried out with respect to vibrations of a timing that corresponds to the interval between frames, unnatural images will be displayed in a case in which the shake correction is carried out.

Thus, the processing of FIG. 3 is carried out in cases in which the frequency of the vibrations is lower than the frame rate of imaging of the rear camera 12. Concretely, as shown in FIG. 4, step 103 is added to the processing of FIG. 3. Namely, in a case in which the determination in step 102 is affirmative, the process proceeds to step 103, and the CPU 18A determines whether or not the frequency of the vibrations is lower than the frame rate of imaging of the rear camera 12. In this determination, the frequency of the vibrations is detected from the results of detection of the acceleration sensor 20, and it is determined whether or not the detected frequency is lower than the frame rate. In a case in which this determination is affirmative, the process proceeds to step 104, and, in a case in which this determination is negative, the process proceeds to step 110. In this way, shake correction is carried out in cases in which the frequency of the vibrations is less than the frame rate, i.e., in cases in which the frequency of the vibrations is a frequency at which vibrations do not arise at a time between a frame image and the next frame image. Therefore, shake correction that is more natural may be possible.

Note that the above exemplary embodiment describes an example in which acceleration is detected as an example of a physical amount that corresponds to the amount of displacement in the vehicle vertical direction of the rearview mirror monitor 14 due to vibrations inputted to the front wheels of the vehicle. However, the physical amount is not limited to this. For example, the stroke of the front suspension may be detected as the physical amount.

Further, description is given in which the display control, which is shown in FIGS. 3 and 4 and is carried out at the control device 18 of the vehicle rear region image display device 10 in the above-described exemplary embodiment, is software processing that is carried out by executing a program, but the display control may be processing that is carried out by hardware. On the other hand, the display control may be processing that combines both hardware and software. Further, the programs that are stored in the ROM 18B may be stored on any of various types of storage media and distributed.

Moreover, the present disclosure is not limited to the above, and, other than the above, may be implemented by being modified in any of various ways within a scope that does not depart from the gist thereof.

What is claimed is:

1. A vehicle rear region image display device comprising:
an imaging section provided at a vehicle rear portion, the imaging section configured to capture images of a vehicle rear region;
a display section provided at a front portion of a vehicle cabin interior, the display section configured to display a displayed image that is obtained by cutting out a predetermined range from the captured image;
a detecting section configured to detect a physical amount corresponding to an amount of displacement in a vehicle vertical direction of the display section due to vibrations at front wheels of a vehicle; and
a control section configured to carry out adjustment control that adjusts a position of cutting out the displayed image from the captured image on the basis of the physical amount, at a timing at which vibrations are inputted to rear wheels of the vehicle by an object that caused input of the vibrations to the front wheels of the vehicle.

2. The vehicle rear region image display device of claim 1, further comprising:
a frequency detecting section configured to detect a frequency of the vibrations,
wherein the control section is configured to carry out the adjustment control in a case in which the frequency detected by the frequency detecting section is lower than a frame rate of the imaging of the imaging section.

3. The vehicle rear region image display device of claim 1, wherein the timing is estimated on the basis of vehicle speed and a length of a wheelbase of the vehicle.

4. A non-transitory computer-readable medium storing a vehicle rear region image display program for causing a computer to function as the control section of the vehicle rear region image display device of claim 1.
